(19) United States
(12) Patent Application Publication
(10) Pub. No.: US 2020/0187471 A1
(43) Pub. Date: Jun. 18, 2020

(54) Oscillating standup jig

(71) Applicant: David Lynn Thorne, Kaysville, UT (US)

(72) Inventor: David Lynn Thorne, Kaysville, UT (US)

(21) Appl. No.: 16/350,631

(22) Filed: Dec. 12, 2018

(51) Int. Cl. A01K 85/10; A01K 85/12; A01K 83/00

(52) U.S. Cl. CPC A01K 85/10; A01K 83/00; A01K 85/12

(57) ABSTRACT

This novel invention for a bladed jig creates a unique swimming motion for attached baits when retrieved and “stands up” when at rest on the bottom underneath water. The bladed jig when retrieve at a rate to maintain the jig near the water's surface or partially above the surface creates a swimming bait motion and wake on the water's surface. Additionally, the bladed jig has an oscillating motion when jigged upwards and when released to descend toward the bottom underneath water to attract fish.

### FIELD OF INVENTION

This invention relates generally to fishing jigs having an oscillating blade that directly drives a weighted body and hook and imparts action to a soft bait attached to the jig. More specifically, this invention relates to a fishing jig that has an oscillating blade and creates an oscillating motion and also “stands-up” (i.e. maintains the hook shank and an attached soft or natural bait suspended above the bottom when the weighted body portion is at rest on a lake, stream or river bottom).

### BACKGROUND AND RELATED ART

Most jigs are not designed to “stand-up” when rigged with soft baits or natural baits and fall over and, therefore, lay flat, at rest, on the bottom of a lake, river or stream. This inclination results in a lure induced bait position that cannot be easily seen nor attacked by nearby fish. Such circumstances limit the opportunity to attract fish. There is a class of “stand up” jigs which are commercially available that either have molded weighted bodies with flat undersides or other features such as wires extending from the weighted body for stabilizing and maintaining the jig in an upright position when at rest underneath water. None of the current “stand-up” jigs in the market incorporate an oscillating blade to create side-side-motion when retrieved through water, either at the water's surface or underneath and provide jig “stand-up” positioning when at rest at water's bottom. Also, when retrieved at a rate fast enough rate, none maintain a portion of a jig near the surface to create an oscillating lure motion and a wake in the water's surface to attract fish to the lure.

There are many types of fishing jigs designed to attract fish. As an example, a fishing jig called a “Scrounger” comprises a weighted body, hook and upright blade designed to oscillate when drawn through water with the axis of oscillation occurring generally about the axis of the hook shank. A resilient blade is attached to the weighted body behind the hook eyelet and extends superiorly above the eyelet to create oscillating motion of attached soft baits or natural baits.

Another fishing jig discloses a line connector in U.S. Patent Application US 2013/0219770 by Inventor, James Ronald Davis (Davis). Davis discloses a fishing line connector having a single width and having a unitary elongated member shaped to form first and second eyelets at each member end. The line connector may be connected to a blade.

A snag-less fishing jig is disclosed in U.S. Patent Application US 2013/0047491 by Inventor, James Ronald Davis (Davis). Davis discloses a snag-less bladed jig having a blade that oscillates during retrieval and pitches forward to protect the hook from snagging upon encountering moss or other elements in the water. The fishing jig is taught to include pitching means for pitching the blade relative to the hook. Further, the upper end of the blade oscillates side-to-side relative to a hook connector.

A snag resistant fishing jig is disclosed in U.S. Pat. No. 7,726,062 B2, issued Jun. 1, 2010 to James Ronald Davis (Davis). Davis discloses a jig with an attached blade. The jig has a weight molded about the shank of a hook with an eyelet disposed to maintain the sharpened point of a hook held upright by the relative dispositions of the eyelet, weight and orientation of the point. The blade is taught to be affixed to the eyelet, and to be limited in oscillation by either collision of the blade with the eyelet or with the weight to which it is directly affixed. Further, the blade is taught to comprise three holes, one of which is used to securely affix the blade to the eyelet. The other two holes are taught to be used in cooperation with a clip affixed to a fishing line for the purpose of releasibly affixing the fishing line of a fishing jig unit which comprises both blade and weighted fishing jig.

Wuensch et al., U.S. Pat. No. 8,028,465 B1, teaches a fishing jig and method of assembly comprising a lip, an eyelet extending forward of the lip. The eyelet being adapted to be attached to the fishing line for pulling the fishing jig through the water in a direction of movement towards the lip such that the lip imparts a movement to the fishing jig. Additionally, a buoyant or neutrally buoyant paddle extending from, and rigidly attached to the lip, having opposed side surfaces that together counterbalance the movement imparted by the lip. The invention includes a hook having a shank that is fixedly attached to and extends from the paddle.

Applicant believes that no fishing jig referenced supra, discloses or teaches significant side-to-side oscillating motion, “stands-up” when at rest on bottom structure and “waking” when at or near the surface of water when fitted with a swimming soft bait or natural bait.

### Definitions:

For purposes of this disclosure, the following definitions apply:
aft, adv, near, toward, or in the rear of a jig away from a line of attachment.
blade, n, a broad flattened part which is affixed to a portion of a fishing jig and which oscillates as the jig is propelled in water to provide a wake following therefrom; such a blade may be rigid or flexible, if flexible such a blade requires a supporting mast to withstand pressure from being displaced through water.
centrally, adv, near, toward the center of gravity, syn: medially.
distal, adj, (see also proximal) indicates the segment of a device normally away from a line attachment of a jig.
fishhook, n, a device, usually made of rigid metal wire, comprising a curved section which has a sharpened point on one end for catching a fish and a shank which comprises a substantially straight portion on an opposite end. Generally, the shank is ultimately affixed with an eyelet and/or split ring to the jig or it may be directly and rigidly affixed to the back portion of the jig.
fishing jig assembly, n, a combination comprising a jig component, a fishhook and a bait which may be natural or artificial
fishhook assembly, n, a combination of a fishhook and other optional attributes associated with the fishhook for attaching the fishhook to a frame and for adding attractive components such as an artificial or natural bait.
fore, adv, in, toward or adjacent to the front (i.e. forward) toward a line of attachment.
inferior, adj, situated lower down or closer to the center of the earth than a referenced site.
jig, n, a fishhook assembly which has a weight affixed about an associated portion of the fishhook and a line connection eyelet.
proximal, adj, indicates the segment of a device normally closely disposed relative to a line attachment of a jig.
shank, n, a frame part which is a proximal portion of a fishhook; the shank usually having a substantially straight portion which is associated with a curved portion of a fishhook and with a connecting link by which the fishhook is affixed to other fishing gear.
stabilizing mass, n: a mass disposed relative to a fishing line connection to provide in-water stability and, by density, jig running depth
substantially, adv,: having a similar form and function which does not materially depart from an ideal or perfect form of the referenced item (e.g. a ball my be considered to be substantially spherical while having minor deformities which cause it to be an imperfect relative to an ideal sphere, a form of which cannot be exactly achieved in “real” life)
superior, adj, situated higher up or away from the center of the earth relative to a referenced site.
yaw, n: oscillatory angular motion or displacement being disposed about an axis subtending substantially orthogonally behind a blade of a jig.
vertical oscillation: oscillatory angular displacement which is substantially disposed about an axis determined by oscillation about an angle of attack of a blade.

### BRIEF SUMMARY AND OBJECTS OF THE INVENTION

Fishing jigs may attract fish using various types of lure motion, flash and vibration. Additional jig features considered favorable to successful jig use such as weed resistance, are castability and realistic bait action when retrieved. Fishing jigs commonly mimic minnows, insects or certain other animals fish prey upon although some jigs may not resemble any specific prey, but provide other general shape features and motion that attract fish. It is generally well known that jigs exhibiting side-to-side motion are very desirable and that such a jig with a stand-up capability to keep the jig and associated bait in view of fish would be highly desirable. Such jigs can be manufactured at reasonable cost may have significant advantages in the fishing market.

This novel, inventive fishing jig provides anglers new and surprising jig motion with stand up jig capability and a jig surface waking option by utilizing a blade attached to the weighted body behind the hook eyelet. So affixed, the blade becomes a “leg” which superiorly disposes tail-side portions of the lure when seated upon an underwater surface due to the forwardly disposed weight.

The blade may have a variety of shapes and is sized to create oscillating motion resulting in side-to-side soft bait action with portions of the blade extending both superiorly, inferiorly as well as extending outwardly on each side. The blade is sized to allow the attached soft bait or natural bait to come to action at very slow speeds allowing maximum time for fish to react.

The blade may be manufactured of metal, plastic or vinyl materials (which may be colored or translucent) to meet certain fishing conditions. The preferred hook is a jig hook style having an eyelet above the shank and a sharpened point rearward of the eyelet and also above the shank. The weighted body may be manufactured of metal or other suitable weighted material. The shape of the weighted body is preferably shaped like the head portion of live prey, but such a design is not required and many varying weighted body shapes may be utilized.

The weighted body may also have a hook molded directly to the weighted body or the weighted body may have a hook loosely secured separately utilizing a hook receiver molded partially into the weighted body and utilizing a hook manufactured with a closable gap in a hook connecting member that may be attached by assembling the hook onto the hook receiver and closing the closable gap forming a closed loop. The hook connecting member may be purchased having a closed loop and is attached to the hook receiving member using a ring (including a split ring) or other connecting snap used for connecting jig components. The hook may have a single sharpened end or multiple sharpened ends such as a treble hook. The hook may be fished alone or with attachment of a live bait or artificial bait. The jig may be manufactured for sale with as few as three components; weighted body, hook and blade. (artificial or natural bait not included in package).

It is a primary objective to provide a fishing jig comprising a weighted body, a hook having a sharpened end portion and a line connection eyelet.

It is a primary objective to provide a fishing jig in which the blade extends outwardly from the weighted body to both create an oscillating motion and a stand up capability when at rest on the bottom underneath water.

Another primary objective is to provide a fishing jig that can be retrieved in a manner such that the jig can be manipulated up and down in the water column and oscillates in a plurality of directions to attract fish.

Another primary objective is to provide a jig having a blade designed to provide an oscillating motion when retrieved at a speed that maintains at least a portion of the jig near or above water and at least a portion below water such that the inferiorly positioned blade portion creates an oscillating action and also creates a wake when drawn across the surface.

These and other objects and features of the present invention will be apparent from the detailed description taken with reference to accompanying drawings.

### BRIEF DESCRIPTION OF THE DRAWINGS

FIG. 1 is a side elevation of a PRIOR ART fishing jig.

FIG. 2 is a perspective of the PRIOR ART fishing jig seen in FIG. 1 at rest on a flat surface to show the jig does not stand up when at rest.

FIG. 3 is a top view of the PRIOR ART jig seen in FIGS. 1 and 2 indicating oscillatory motion is generally along the axis of the soft bait or natural bait.

FIG. 4 is a side view of a preferred embodiment of an oscillating stand up jig made according to the instant invention, with soft bait attached.

FIG. 5 is a perspective view of the jig seen in FIG. 4, showing stand up capability when at rest at water bottom.

FIG. 6 is a side view of the jig seen in FIG. 4, without an attached soft bait.

FIG. 7 is a top view of the oscillating stand-up jig seen in FIG. 5 showing a wide side-to-side motion created by the blade.

FIG. 8 is a frontal view of a preferred oscillating blade design showing the blade having more material extending horizontally on each side than superiorly or inferiorly.

These and other objects and features of the present invention will be apparent from the detailed description taken with reference to accompanying drawings.

### DETAILED DESCRIPTION OF THE ILLUSTRATED EMBODIMENTS

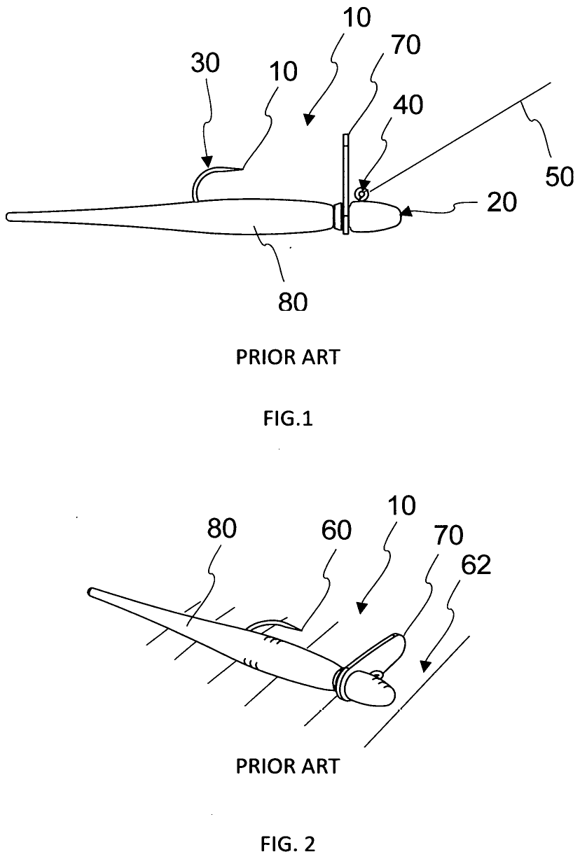

Reference is now made to the embodiments illustrated in FIGS. 1-8 wherein like numerals are used to designate like parts throughout.

Reference is now made to FIG. 1, wherein a PRIOR ART jig 10 is shown having a weighted body 20 with attached hook 30. The PRIOR ART jig 10 hook 30 has a loop 40 for tying a fishing line 50 and a rearward sharpened end 60. The PRIOR ART jig 10 also has a blade 70 that extends generally vertically to create an oscillatory jig motion when drawn through water.

Reference is now made to FIG. 2, wherein the PRIOR ART fishing jig 10 is disposed on its side with the hook 30 and bait 80 parallel to the surface and unable to “stand-up” to present the bait 80 and hook sharpened end 60 parted from the water bottom.

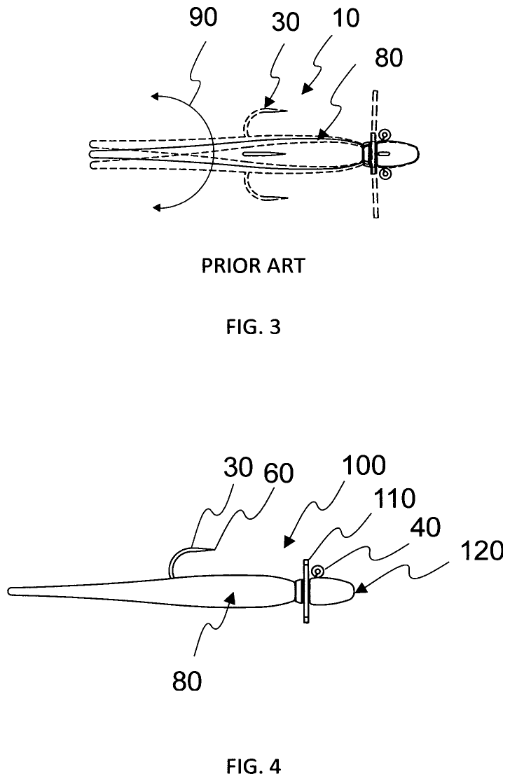

Reference is now made to FIG. 3, wherein PRIOR ART jig 10 is shown in motion in water with resulting oscillatory motion of the bait 80 when run through water with limited side-to-side transverse motion of bait 80 as indicated by arched arrow 90.

Reference in now made to FIG. 4 wherein a novel oscillating stand up jig 100, made according to the present invention, is designed for use with a soft bait 80 or a natural bait, not shown, for catching fish. The jig may be cast and retrieved using a steady retrieve, jigged up and down in the water column, or slowly moved along bottom structure under water to attract fish. The jig may also be retrieved at a speed that brings the lure near or partially above the surface to create a wake on the water's surface while the bait is “swimming” side-to-side. The jig comprises a blade 110 attached to a weighted body 120. The blade 110 may be manufactured of metal, plastic or other materials that withstand hydraulic forces to oscillate when drawn through water. Jig 100 is securely affixed to weighted body 120 to which jig hook 30 is securely attached. Weighted body 120 may be made out of metal or other materials suitable provide sufficient weight to allow for blade 110 oscillation when retrieved in water. Weighted body 120 may be manufactured using any suitable metal or a combination of metal and plastic. Jig hook 30 having a sharpened point 60 and a fishing line receiver portion 40 for tying a fishing line thereto.

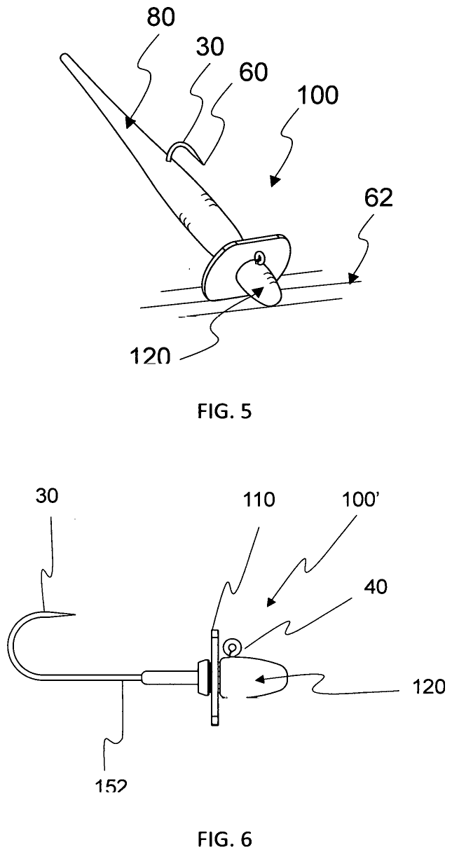

Reference is now made to FIG. 5 wherein the jig 100 is seen in a “stand-up” state with hook 30 sharpened end 60 and bait 80 displaced from water bottom 62.

Reference is now made to FIG. 6 wherein the jig 100′ is seen with only a blade 110 and a hook 30 attached being without attached bait 80 (see FIG. 5).

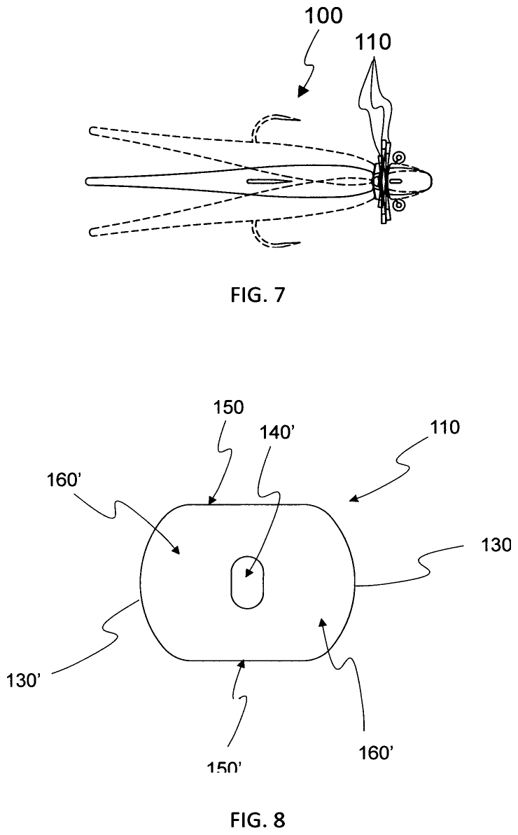

Reference is now made to FIG. 7 wherein the jig 110 is shown with the attached bait 80 in exemplary motion performing broad side-to-side transverse oscillatory motion created by oscillation of blade 110. Note that blade 110 has been specifically designed and shaped to create such motion.

Reference is now made to FIG. 8 wherein shape of oscillatory blade 110 is seen. The preferred shape of blade 110 comprises horizontal sides 130 and 130′ which extend outwardly farther from a central hole 140 than superior blade edge 150 and inferior blade edge 150′. This blade 110 geometry enhances the wide side-to-side jig motion. Fishing jig blade 110 is positioned on the blade connector single wire shank of hook 30 (see FIG. 6), with blade 110 having greater surface area 160 inferior to blade hole 140 than a blade surface area 160′ superiorly disposed relative to blade hole 140.

1. A fishing jig for presenting bait displaced from a water bottom when at rest thereat, for having a wide range of angular motion when displaced through water and for making a wake when displaced through water at the surface thereof, said jig comprising:
a weighted body;
a hook comprising an elongated shank to which said weighted body is affixed at a fore end of said jig and a curved section integrally affixed to an aft portion of said shank and ending in a superiorly disposed sharpened hook point;
a frontal eyelet securely affixed to said body and superiorly exposed therefrom whereby a fishing line is affixed to said jig, said eyelet being superiorly disposed relative to said shank, with the aft portion of said shank being disposed rearward from the line tie eyelet; and
a blade securely affixed to said jig rearward of said eyelet and extending superiorly above the weighted body, inferiorly below the weighted body, and laterally outward in opposite directions away from the superior portion and inferior body portion, said blade comprising a shape which causes said jig to oscillate with enhanced side-to-side motion and further comprising inferiorly disposed length which causes said jig to achieve a “stand-up” position when at rest on a bottom under water surface with said hook point being upwardly disposed relative to said weighted body.
